(19) United States
(12) Patent Application Publication
(10) Pub. No.: US 2016/0011361 A1
(43) Pub. Date: Jan. 14, 2016

(54) WHITE LED LIGHT SOURCE, BACKLIGHT MODULE AND DISPLAY DEVICE

(71) Applicants: BOE TECHNOLOGY GROUP CO., LTD., Beijing (CN); BEIJING BOE VISION-ELECTRONIC TECHNOLOGY CO., LTD., Beijing (CN)

(72) Inventors: Xiao ZHANG, Beijing (CN); Jianmin HE, Beijing (CN); Lijie ZHANG, Beijing (CN)

(21) Appl. No.: 14/583,926

(22) Filed: Dec. 29, 2014

(30) Foreign Application Priority Data
Jul. 8, 2014 (CN) 201410323949.5

(51) Int. Cl. F21V 8/00; F21K 99/00

(52) U.S. Cl. CPC G02B 6/0068; F21K 9/56; G02B 6/0026; G02B 6/003; G02B 6/009

(57) ABSTRACT

The present disclosure relates to a white LED light source, a backlight module and a liquid crystal display device. The white LED light source comprises a light strip having a plurality of LED units and a plurality of laser units. Each LED unit has a chip emitting lights of a first color light and a fluorescent module induced by the lights of the first color to emit lights of a second color. The plurality of laser units emit lights of a third color so as to form white lights by mixing the lights of the second color emitted by the LED units and the lights of the third color emitted by the laser units. In the white LED light source according to the present disclosure, laser units are used so as to expand the color gamut of the liquid crystal display device.

### FIELD

The present disclosure relates to a white light emitting diode (LED) light source, a backlight module and a display device.

### BACKGROUND

A conventional liquid crystal display device comprises a display panel and a backlight module. The display panel does not emit lights and is typically provided with the backlight module which provides light sources necessary for normal display. Thus, the light emitting effect of the backlight module affects the display effect of the display panel directly, which in turn affects the visual effect of the liquid crystal display device under operation. Currently, the light source of the backlight module in the liquid crystal display mainly includes Cold Cathode Fluorescent Lamp (CCFL) light source and a Light Emitting Diodes light source (LED). Due to the advantages of the LED such as high luminance, high color purity, long service life, good reliability and no mercury contamination, the LED light source has an increasing market share in the backlight module.

With the development of the liquid crystal display technology, a white LED light source is widely used in the present liquid crystal display device so as to meet the slim design demands of the liquid crystal display device. As shown in FIG. 1, a conventional white LED light source comprises an LED unit strip 01 and a plurality of LED 02 mounted on the LED unit strip 01. Each LED 02 comprises a blue light chip and a fluorescent module. The blue light chip emits a blue light on the fluorescent module so as to induce the fluorescent powders in the fluorescent module to emit eventual white lights from the LED light source.

However, the typical fluorescent powder in the fluorescent module is a mixed fluorescent powder of a green fluorescent powder and a red fluorescent powder. Since the red fluorescent powder in the white LED light source has a relatively low color purity, the red component in the lights emitted by the white LED light source has a relatively low color purity such that the liquid crystal display device using such white LED light source as a backlight has a relatively low color gamut. The color gamut of the liquid crystal display device is about 30% under the CIE1976 standard, which adversely affects the display effect of the liquid crystal display device.

### SUMMARY OF THE INVENTION

The present disclosure provides a white LED light source, a backlight module and a display device.

In one aspect, the present disclosure provides a white LED light source comprising a light strip having a plurality of LED units and a plurality of laser units. Each LED unit has a chip emitting lights of a first color light and a fluorescent module induced by the lights of the first color to emit lights of a second color. The plurality of laser units emit lights of a third color so as to form white lights by mixing the lights of the second color emitted by the LED units and the lights of the third color emitted by the laser units.

In the white LED light source according to the present disclosure, each LED unit has positive lead and negative lead connected between two conductive metals in the light strip, which are insulated to each other and connected to a positive and a negative terminals of a power supply. The positive and negative lead of each laser unit are also connected between two conductive metals, respectively. After the white LED light source is powered on, the two conductive metals and the LED unit in the light strip form a conductive circuit, so that the powered chip in the LED unit emits lights of the first color, irradiates the fluorescent powder in the fluorescent module and induces the fluorescent powder to emit lights of the second color. At the same time, the two conductive metals and the laser unit form a conductive circuit, so that the powered laser unit emits lights of the third color. The lights of the second color emitted by the LED units and the lights of the third color emitted by the laser units are combined to form white lights.

In the white LED light source according to the present disclosure, the fluorescent powder emitting the lights of the third color light induced by the lights emitted from the chip in the conventional fluorescent module is replaced by laser units. The lights of the third color emitted from the white LED light source is provided by the laser unit directly, thus enhancing the color purity of the lights of the third color, so as to expand the color gamut of the white LED light source of the liquid crystal display device according to the present disclosure. Therefore color brightness displayed by the liquid crystal display device is increased so as to enhance the display effect of the liquid crystal display device.

In one example, the laser unit is a red laser LED; the chip is a blue light chip emitting blue lights; and the fluorescent module has a green color fluorescent powder.

In one example, the red laser LED has a working wavelength of about 650 nm. In this case, the color purity of the red lights emitted by the red laser unit is ensured, enhancing the color brightness displayed by the liquid crystal display device having the white LED light source according to the first embodiment of the present disclosure, and improving the display quality of the liquid crystal display device.

In one example, the red color laser units are embedded in the light strip so as to improve the stability of the laser units mounted on the light strip.

In one example, in the light strip, at least one LED unit for example one or two LED units are provided between any two adjacent the laser units. Thus, the laser units and LED units are arranged alternately, so that the third color lights emitted by the laser units and the second color lights emitted by the LED units can be mixed more uniformly, which facilitates the sufficient combination of the third color lights emitted by the laser units and the second color lights emitted by the LED units so as to form the white light.

In one example, the white LED light source further comprises a beam expander provided on a light emitting side of the respective laser unit for expanding laser beam emitted by the laser unit.

In another aspect, the present disclosure provides a backlight comprising at least one of the white LED light source described as above.

In one example, the backlight further comprises a light guide plate. The light guide plate has a side surface facing light emitting surface of the white LED light source and embedded with a lens array for expanding light beams emitted from the laser units. With the side type backlight module having the above-mentioned white LED light source, the thickness of the display device can be decreased.

Since the lights of the third color emitted from the white LED light source is provided by the laser unit directly, the color purity of the lights of the third color is enhanced so as to expand the color gamut of the white LED light source of the liquid crystal display device according to the present disclosure. Therefore color brightness displayed by the liquid crystal display device is increased so as to enhance the display quality of the liquid crystal display device.

In addition, the present disclosure provides a display device comprising a backlight module described as above.

Based on the advantages of the above-mentioned backlight module, the liquid crystal display having the above-mentioned backlight module according to the present disclosure can have an expanded color gamut, thus enhancing color brightness of the liquid crystal display device and enhancing the display quality of the liquid crystal display device.

### BRIEF DESCRIPTION OF THE DRAWINGS

In order to clearly illustrate the technical solution of the present disclosure, the technical solution of the present disclosure will be further described with reference to the following drawings. The drawings described in the following are only related to a part of embodiments of the technical solution of the present disclosure.

FIG. 1 is a structural schematic view of a conventional white LED light source;

FIG. 2 is a structural schematic view of a white LED light source according to a first embodiment of the present disclosure; and

FIG. 3 is a structural schematic view of another white LED light source according to a first embodiment of the present disclosure.

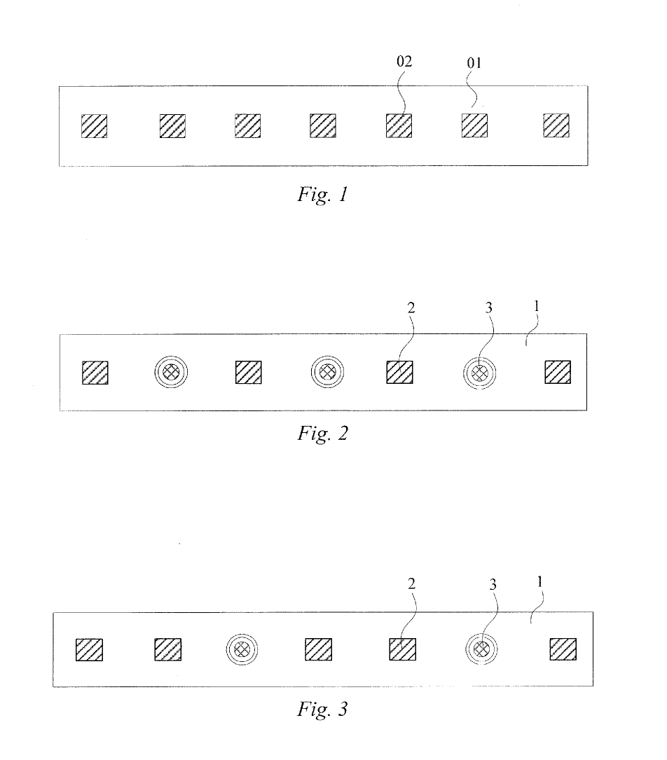

### DESCRIPTION OF THE EMBODIMENTS

The technical solution of the embodiments of the present disclosure will be described clearly and fully in connection with the drawings of the embodiments of the present disclosure. It is obvious that the described embodiments are just a part but not all of the embodiments of the present disclosure. Based on the described embodiments of the present disclosure, those skilled in the art can obtain all other embodiment without any inventive work, which all fall into the scope of the claimed invention.

Unless otherwise defined, technical terms or scientific terms used herein shall have a common meaning known by those skilled in the art of the present disclosure. Words and expressions such as “first”, “second” and the like used in the description and claims of the patent application of the present disclosure do not denote any sequence, quantity or importance, but distinguish different components. Likewise, words such as “a”, “an” and the like do not denote quantitative restrictions, but denote the presence of at least one. Words such as “connected”, “connecting” and the like are not restricted to physical or mechanical connections, but may include electrical connections, regardless of direct or indirect connections. Words such as “up”, “below”, “left”, “right”, etc., are only used to denote the relative positional relationship. Upon the absolute position of the described object changes, the relative positional relationship change correspondingly.

### First Embodiment

Referring to FIG. 2, a white LED light source according to the first embodiment comprises a light strip 1 having a plurality of LED units 2 and a plurality of laser units 3. Each LED unit 2 have a chip emitting lights of a first color and a fluorescent module emitting lights of a second color induced by the lights of the first color. The plurality of laser units 3 emit lights of a third color. The lights of the third color emitted by the laser units and the lights of the second color emitted by the LED unit can be mixed to form a white light.

In the white LED light source according to the first embodiment, each LED unit 2 has positive lead and negative lead connected between two conductive metals in the light strip I, which are insulated to each other and connected to a positive and a negative terminals of a power supply, respectively. The positive lead and negative lead of each laser unit 3 are also connected between two conductive metals, respectively. After the white LED light source is powered on, the two conductive metals and the LED unit 2 in the light strip 1 form a conductive circuit, so that the powered chip in the LED unit 2 emits lights of the first color, irradiates the fluorescent powder in the fluorescent module and induces the fluorescent powder to emit lights of the second color. At the same time, the two conductive metals and the laser unit in the light strip 1 form a conductive circuit, so that the powered laser unit 3 emits lights of the third color. The lights of the second color emitted by the LED units 2 and the lights of the third color emitted by the laser units 3 are combined to form white lights.

In the white LED light source according to the first embodiment, the fluorescent powder emitting the lights of the third color light induced by the lights emitted from the chip in the conventional fluorescent module is replaced by laser units 3. The lights of the third color emitted from the white LED light source is provided by the laser unit 3 directly, thus enhancing the color purity of the lights of the third color, so as to expand the color gamut of the white LED light source of the liquid crystal display device according to the present disclosure. Therefore color brightness displayed by the liquid crystal display device is increased so as to enhance the display effect of the liquid crystal display device.

In an example, laser unit 3 is a red laser LED; the chip is a blue light chip emitting blue lights; and the fluorescent module is a fluorescent module having a green fluorescent powder. After the white LED light source is powered on, the powered blue chip in the LED unit emits blue lights and the blue lights irradiates on the green fluorescent powder in the fluorescent module and induce the green fluorescent powder to emit lights of a cyan color. At the same time, the powered laser unit emits lights of red color. The lights of the cyan color emitted by the LED units 2 and the lights of red color emitted by the laser units 3 are combined to form white lights. Thus, the red light component in the lights emitted by the white LED light source is provided directly by the red laser LED, thus enhancing the red color purity in the lights emitted by the white LED light source.

In an example, the above-mentioned red laser LED has a working wavelength of 650 nm. The color purity of the red lights emitted by the red laser unit is ensured, thus enhancing the color brightness of the liquid crystal display device having the white LED light source according to the first embodiment, and improving the display quality of the liquid crystal display device.

In some optional embodiments, the above-mentioned red color laser unit 3 is embedded in the light strip 1, thus increasing the stability of the laser units 3 mounted on the light strip 1.

In the above-mentioned embodiments, at least one LED unit 2 is disposed between any two adjacent laser units 3 across the entire light strip 1. More preferably, as shown in FIG. 2, one LED unit 2 is provided between two adjacent laser units 3. Alternatively, as illustrated in FIG. 3, two LED units 2 are provided between two adjacent laser units 3.

Thus, laser units 3 and LED units 2 are arranged alternately, so that the third color lights emitted by the laser units 3 and the second color lights emitted by LED units 2 are distributed more uniformly across the light strip 1, which facilitates the sufficient combination of the third color lights emitted by the laser units 3 and the second color lights emitted by the LED units 2 so as to form the white light.

The number and arrangement of LED units 2 and laser units 3 on light strip 1, can be set based on the actual requirement, and will not be described in details herein.

In one preferred embodiment, a laser beam expander is provided on a light emitting side of the respective laser unit 3 so as to expand the small laser beam emitted by the laser unit 3. For example, the laser beam expander can be a collimated light beam expander, lens or a diaphragm.

### Second Embodiment

A backlight module according to the second embodiment includes at least one white LED light source described in the embodiments described as above.

Since the third color lights of the lights emitted by the white LED light source according to the first embodiment has a relatively high color purity, the third color light component in the back lights emitted by the backlight module according to the second embodiment having the white LED light source according to the first embodiment has a relatively high color purity, so as to expand the color gamut of the liquid crystal display device having the backlight module and enhance the display quality of the liquid crystal display device.

In one preferred embodiment, the backlight module is a side type backlight module further comprising a light guide plate. The light guide plate has a side surface facing light emitting surface of the white LED light source and embedded with a lens array for expanding light beams emitted from the laser units. With the side type backlight module having the white LED light source according to the first embodiment, the thickness of the display device can be decreased.

### Third Embodiment

A liquid crystal display device according to the third embodiment comprises a backlight module according to the second embodiment.

Based on the advantages of the backlight module according to the second embodiment, the liquid crystal display according to the third embodiment can have an expanded color gamut, thus increasing the color brightness of the liquid crystal display device and enhancing the display quality of the liquid crystal display device.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable the skilled in the art to best utilize the invention in various embodiments and with various modifications as are suited to the particular use contemplated. It is intended that the scope of the invention be defined by the claims appended hereto.

What is claimed is:

1. A white LED light source comprising a light strip having a plurality of LED units and a plurality of laser units,
wherein each LED unit has a chip emitting lights of a first color light and a fluorescent module induced by the lights of the first color to emit lights of a second color;
the plurality of laser units emit lights of a third color so as to form white lights by mixing the lights of the second color emitted by the LED units and the lights of the third color emitted by the laser units.

2. The white LED light source according to claim 1, wherein the laser unit is a red laser LED; the chip is a blue light chip emitting blue lights; and the fluorescent module has a green color fluorescent powder.

3. The white LED light source according to claim 2, wherein the red laser LED has a working wavelength of about 650 nm.

4. The white LED light source according to claim 1, wherein the red color laser units are embedded in the light strip.

5. The white LED light source according to claim 1, wherein in the light strip, at least one LED unit is provided between any two adjacent the laser units.

6. The white LED light source according to claim 1, further comprising a beam expander provided on a light emitting side of the respective laser unit for expanding laser beam emitted by the laser unit.

7. A backlight module comprising at least one white LED light source comprising a light strip having a plurality of LED units and a plurality of laser units,
wherein each LED unit has a chip emitting lights of a first color light and a fluorescent module induced by the lights of the first color to emit lights of a second color;
the plurality of laser units emit lights of a third color so as to form white lights by mixing the lights of the second color emitted by the LED units and the lights of the third color emitted by the laser units.

8. The backlight module according to claim 7, wherein the laser unit is a red laser LED; the chip is a blue light chip emitting blue lights; and the fluorescent module has a green color fluorescent powder.

9. The backlight module according to claim 8, wherein the red laser LED has a working wavelength of about 650 nm.

10. The backlight module according to claim 7, wherein the red color laser units are embedded in the light strip.

11. The backlight module according to claim 7, wherein in the light strip, at least one LED unit is provided between any two adjacent the laser units.

12. The backlight module according to claim 7, wherein the white LED light source further comprises a beam expander provided on a light emitting side of the respective laser unit for expanding laser beam emitted by the laser unit

13. The backlight module according to claim 7, further comprising a light guide plate, wherein the light guide plate has a side surface facing light emitting surface of the white LED light source and embedded with a lens array for expanding light beams emitted from the laser units.

14. A display device comprising a backlight module comprising at least one white LED light source, the white LED light source comprising a light strip having a plurality of LED units and a plurality of laser units,
wherein each LED unit has a chip emitting lights of a first color light and a fluorescent module induced by the lights of the first color to emit lights of a second color;
the plurality of laser units emit lights of a third color so as to form white lights by mixing the lights of the second color emitted by the LED units and the lights of the third color emitted by the laser units.

15. The display device according to claim 14, wherein the laser unit is a red laser LED; the chip is a blue light chip emitting blue lights; and the fluorescent module has a green color fluorescent powder.

16. The display device according to claim 15, wherein the red laser LED has a working wavelength of about 650 nm.

17. The display device according to claim 14, wherein the red color laser units are embedded in the light strip.

18. The display device according to claim 14, wherein in the light strip, at least one LED unit is provided between any two adjacent the laser units.

19. The display device according to claim 14, wherein the white LED light source further comprises a beam expander provided on a light emitting side of the respective laser unit for expanding laser beam emitted by the laser unit

20. The display device according to claim 14, wherein the backlight module further comprises a light guide plate, wherein the light guide plate has a side surface facing light emitting surface of the white LED light source and embedded with a lens array for expanding light beams emitted from the laser units.
